(19) United States
(12) Patent Application Publication
(10) Pub. No.: US 2007/0107255 A1
(43) Pub. Date: May 17, 2007

(54) Drying apparatus

(75) Inventors: Tomoichiro Tamura, Kyoto (JP); Yuuichi Yakumaru, Osaka (JP); Masaya Honma, Osaka (JP); Fumitoshi Nishiwaki, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: MATSUSHITA ELECTRIC INDUSTRIAL CO., LTD., Osaka (JP)

(21) Appl. No.: 10/581,083

(22) PCT Filed: Apr. 7, 2005
(86) PCT No.: PCT/JP05/06843

§ 371 Date: May 31, 2006

(30) Foreign Application Priority Data
Apr. 9, 2004 (JP) 2004-114901

(51) Int. Cl. F25D 17/04; F26B 3/00; F25B 49/00

(52) U.S. Cl. 34/475; 62/176.1; 34/477; 34/465

(57) ABSTRACT

It has been difficult to operate a drying apparatus in a stable and high-efficiency state where a superheat value is changed in a drying process. A drying apparatus includes: a first temperature sensor 38 which detects the temperature of a refrigerant between the outlet of an evaporator 34 and the inlet of a compressor 31; and control means 14 for controlling a superheat value by changing flow resistance of an expansion valve 33 based on a detected value of the first temperature sensor 38. The control means 14 controls the superheat value in the drying process to become a target value.

### TECHNICAL FIELD

The present invention relates to a drying apparatus used for drying clothing or bathroom, or used for dehumidify a room.

### BACKGROUND OF THE INVENTION

As a conventional drying apparatus, there is a cloth drier in which a heat pump apparatus is used as a heat source and drying air is circulated (see patent document 1, for example). FIG. 11 shows a structure of the conventional drying apparatus described in the patent document 1.

In the drying apparatus (cloth drier) shown in FIG. 11, a rotation drum 2 is used as a drying room. The rotation drum 2 is provided in a body 1 of the clothing dryer so as to rotate freely. The rotation drum 2 is driven by a motor 3 through a drum belt 4. Further, a blower 22 is driven by the motor 3 through a fan belt 8. Drying air is sent from the rotation drum 2 to a circulation duct 18 through a filter 29 and a rotation drum-side air intake 10 by the blower 22.

Further, the heat pump apparatus is provided with: an evaporator 23 which evaporates a refrigerant to dehumidify drying air; a condenser 24 for condensing the refrigerant to heat the drying air; a compressor 25 for generating a pressure difference in the refrigerant; an expansion mechanism 26 such as a capillary tube for maintaining the pressure difference in the refrigerant; and a pipe 27 through which the refrigerant passes. A portion of the drying air heated by the condenser 24 is discharged outside from the body 1 through an exhaust port 28. An allow B shows flow of the drying air.

Next, the operation of the cloth drier shown in FIG. 11 will be explained. First, clothing 21 to be dried is placed in the rotation drum 2. Then, when the motor 3 is rotated, the rotation drum 2 and the blower 22 rotate, whereby the flow B of the drying air is generated. The drying air absorbs water from the clothing 21 in the rotation drum 2 and takes up much moisture, and then, the drying air is sent to the evaporator 23 of the heat pump apparatus through the circulation duct 18 by the blower 22. The drying air from which heat is absorbed by the evaporator 23 is dehumidified and sent to the condenser 24 to be heated therein, and the air is again circulated into the rotation drum 2. A drain outlet 19 is provide in a middle portion of the circulation duct 18, and a drain generated by dehumidifying the drying air in the evaporator 23 is discharged out through the drain outlet 19. As a result, the clothing 21 is dried.

(Patent Document 1)

Japanese Patent Application Laid-open No. H7-178289

However, the cloth drier shown in FIG. 11 cannot control a superheat value that changes in the drying process.

In this regard, a reason why the superheat value changes with the progress of the drying operation will be explained. Generally, in the case where a solid body is to be dried using warm air, content of water on a surface of the solid body to be dried is reduced with the progress of the drying operation, whereby the drying speed is reduced. In other words, with the progress of the drying operation, the amount of water included in the drying air after passing through a subject to be dried is reduced, and the absolute humidity of suction air in the evaporator 23 is reduced. This makes an endothermic value due to condensation of water in the evaporator 23 lower, whereby the superheat value is reduced. If the superheat value becomes zero, the refrigerant sucked in the compressor 25 becomes gas-liquid two-phase state. Therefore, in the case where the compressor 25 carries out compression of the liquid refrigerant, a risk that the compressor is damaged may occur.

Further, there is relation, as shown in FIG. 9, between a superheat value (SH) and coefficient of performance (COP) of the heat pump apparatus (that is, heating capability/compressor input), and an optimum superheat value exists therein. This principle is shown in FIG. 10. In the case where the superheat value becomes too large (SH Large), a workload of the compressor (that is, an enthalpy difference between those in suction and discharge conditions when the refrigerant is adiabatically compressed from a compressor suction condition) is increased as compared with the case in the optimum superheat value (Optimum SH), whereby the heat pump performance is deteriorated. On the other hand, in the case where the superheat value becomes too small (SH Small), compressor discharge temperature is lowered, and heating performance is deteriorated, whereby the heat pump performance is deteriorated. For this reason, if the superheat value can be controlled to the optimum value, it is possible to reduce power consumption required for the drying operation.

It is therefore an object of the present invention to provide a drying apparatus which can avoid liquid back to a compressor that has been a conventional problem by controlling a superheat value to a predetermined value.

Further, it is known that, as a general drying property, a drying layer between an evaporation surface and a surface of a subject to be dried becomes heat transfer resistance, and heat quantity from drying air to moisture that exists on the evaporation surface is lowered. For this reason, in the case where the heat pump apparatus operates so as to maintain the optimum superheat value as shown in FIG. 9 even close to completion of drying, it tends to make the drying time become longer.

It is therefore another object of the present invention to provide a drying apparatus that can reduce drying time by changing a superheat value.

### DISCLOSURE OF THE INVENTION

A first aspect of the present invention provides a drying apparatus including a heat pump apparatus composed by sequentially connecting in series: a compressor that compresses a refrigerant; a radiator that radiates the refrigerant discharged from the compressor; an expansion valve that expands the refrigerant radiated in the radiator; and an evaporator that evaporates the refrigerant expanded by the expansion valve, and an air channel in which drying air heated in the radiator is introduced to a subject to be dried. In this case, the drying air that absorbs moisture from the subject to be dried is dehumidified in the evaporator, and the dehumidified air is then heated in the radiator again to reuse the dehumidified air as the drying air. The drying apparatus includes:

a first temperature sensor for detecting the temperature of the refrigerant between the outlet of the evaporator and the inlet of the compressor; and

control means for controlling a superheat value by changing flow resistance of the expansion valve based on a detected value of the first temperature sensor.

According to the first aspect, it is possible to maintain an optimum superheat value by changing flow resistance of the expansion valve based on the detected value of the first temperature sensor.

A second aspect of the present invention is characterized that, in the drying apparatus of the first aspect, the drying apparatus further includes:

storage means for storing correlation data between time elapsing from start of operation of the heat pump apparatus and evaporation temperature of the refrigerant in the evaporator, and a target superheat value in advance;

a timer for detecting operation time of the heat pump apparatus; and

processing means which estimates the evaporation temperature of the refrigerant based on the operation time detected by the timer and the correlation data stored in the storage means, and then estimates a superheat value based on the estimated evaporation temperature and the detected value detected by the first temperature sensor,

wherein the control means controls the flow resistance of the expansion valve so that the superheat value estimated by the processing means becomes the target superheat value stored in the storage means.

According to the second aspect, it is possible to control the estimated superheat value so as to become the target superheat value in the drying process, and this makes it possible to reduce power consumption or time required for the drying process.

A third aspect of the present invention is characterized that, in the drying apparatus of the first aspect, the drying apparatus further includes:

storage means for storing a target superheat value in advance;

second temperature sensor for detecting the temperature of the refrigerant between the outlet of the expansion valve and the inlet of the evaporator; and

processing means which calculates a superheat value based on a detected value detected by the second temperature sensor and the detected value detected by the first temperature sensor,

wherein the control means controls the flow resistance of the expansion valve so that the superheat value calculated by the processing means becomes the target superheat value stored in the storage means.

According to the third aspect, it is possible to measure the superheat value in the drying process more precisely.

A fourth aspect of the present invention is characterized that, in the drying apparatus of the second aspect, the control means controls the flow resistance of the expansion valve so that the superheat value after the operation time of the heat pump apparatus elapses beyond predetermined time becomes larger than that before the predetermined time elapses.

According to the fourth aspect, by making the superheat value become larger after the operation time of the heat pump apparatus elapses beyond the predetermined time, it is possible to shorten the drying time.

A fifth aspect of the present invention is characterized that, in the drying apparatus of the third aspect, the drying apparatus further includes:

a timer for detecting operation time of the heat pump apparatus, wherein the control means controls the flow resistance of the expansion valve so that the superheat value after the operation time of the heat pump apparatus elapses beyond predetermined time becomes larger than that before the predetermined time elapses.

According to the fifth aspect, by making the superheat value become larger after the operation time of the heat pump apparatus elapses beyond the predetermined time, it is possible to shorten the drying time.

A sixth aspect of the present invention is characterized that, in the drying apparatus of the fourth or fifth aspect, the drying apparatus further includes:

selection means for selecting whether to apply the superheat value larger than that before the predetermined time elapses to that after predetermined time elapses or not.

According to the sixth aspect, it is possible to select either reduction of the power consumption or shortening of the drying time in response to intention of a user of the drying apparatus.

A seventh aspect of the present invention is characterized that, in the drying apparatus of the first aspect, the drying apparatus further includes:

a third temperature sensor for detecting the temperature of the refrigerant between the outlet of the compressor and the inlet of the expansion valve.

According to the seventh aspect, it is possible to measure the temperature of the refrigerant discharged from the compressor in addition to the superheat value.

An eighth aspect of the present invention is characterized that, in the drying apparatus of the sixth aspect, in the case where a detected value detected by the third temperature sensor becomes predetermined temperature or more, the control means controls the expansion valve so as to make the flow resistance of the expansion valve smaller.

According to the eighth aspect, it is possible to prevent any component of the compressor (for example, a seal member) or refrigerating machine oil from deteriorating due to abnormal rise in the temperature of the refrigerant in the drying process, and this makes it possible to enhance the reliability of the compressor.

A ninth aspect of the present invention is characterized that, in the drying apparatus of the first aspect, the drying apparatus further includes:

discharge pressure detecting means for detecting discharge pressure of the compressor.

According to the ninth aspect, it is possible to measure the pressure of the refrigerant discharged from the compressor in addition to the superheat value.

A tenth aspect of the present invention is characterized that, in the drying apparatus of the eighth aspect, in the case where a detected value detected by the discharge pressure detecting means becomes predetermined pressure or more, the control means controls the expansion valve so as to make the flow resistance of the expansion valve smaller.

According to the tenth aspect, since the refrigerant pressure does not exceed an upper limit value of withstanding pressure in the drying process, it is possible to enhance the reliability of the drying apparatus.

### EFFECT OF THE INVENTION

According to the drying apparatus of the present invention, it is possible to control the superheat value to a target value in the drying process. Therefore, it is possible to avoid liquid back to the compressor that has been a conventional problem, and to shorten the drying time.

### BRIEF DESCRIPTION OF THE DRAWINGS

FIG. 1 shows a structure of a drying apparatus of a first embodiment according to the present invention;

FIG. 2 shows a control flowchart of the drying apparatus of the first embodiment;

FIG. 3 shows a structure of a drying apparatus of a second embodiment according to the present invention;

FIG. 4 is a control flowchart of the drying apparatus of the second embodiment;

FIG. 5 shows a structure of a drying apparatus of a third embodiment according to the present invention;

FIG. 6 is a control flowchart of the drying apparatus of the third embodiment;

FIG. 7 shows a structure of a drying apparatus of a fourth embodiment according to the present invention;

FIG. 8 is a control flowchart of the drying apparatus of the fourth embodiment;

FIG. 9 shows a relation between the superheat and COP (coefficient of performance);

FIG. 10 shows a Mollier diagram showing behavior of a refrigeration cycle when the superheat is changed; and

FIG. 11 shows a structure of the conventional drying apparatus described in the patent document 1.

### DESCRIPTION OF THE NUMERALS

11 storage means

12 operating time detecting means (Timer)

13 processing means

14 control means

31 compressor

32 radiator

33 expansion valve

34 evaporator

35 pipe

36 subject to be dried

37 blowing fan

38 first pipe temperature detecting means (first temperature sensor)

39 second pipe temperature detecting means (second temperature sensor)

40 third pipe temperature detecting means (third temperature sensor)

41 circulation duct (air channel)

42 discharge pressure detecting means

### BEST MODE FOR CARRYING OUT THE INVENTION

### First Embodiment

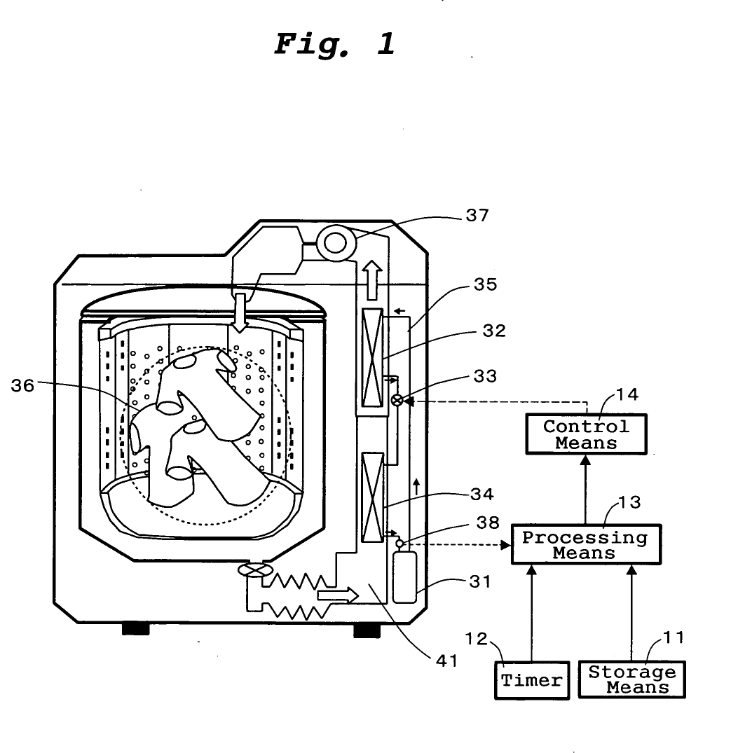

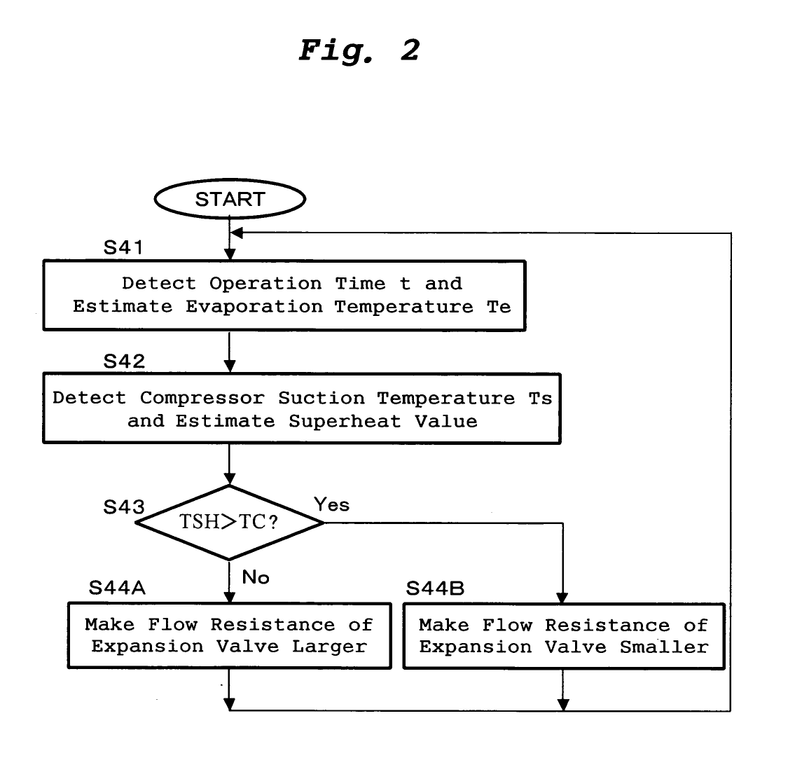

Preferred embodiments of the present invention will be explained with reference to the appending drawings. FIG. 1 shows a structure of a drying apparatus of a first embodiment according to the present invention. FIG. 2 shows a control flowchart of the drying apparatus of the first embodiment.

Referring to FIG. 1, a drying apparatus of the present embodiment includes a heat pump apparatus, and an air channel 41 in which the heat pump apparatus is used as a heat source for drying a subject to be dried and drying air is circulated and reused. The heat pump apparatus includes: a compressor 31 for compressing a refrigerant; a radiator 32 for condensing the refrigerant by heat radiation effect to heat the drying air; an expansion valve 33 for reducing the pressure of the refrigerant; and an evaporator 34 for evaporating the refrigerant by endothermic effect to dehumidify the drying air. These elements of the heat pump apparatus are connected in series to one another through a pipe 35 in this order. As the refrigerant used for this heat pump apparatus, a refrigerant which can be brought into a supercritical state on the radiation side (that is, a discharge portion of the compressor 31 to the radiator 32 to the inlet of the expansion valve 33), for example, carbon dioxide or the like is charged into the pipe 35.

Further, in the air channel 41 of the drying apparatus, the radiator 32 and the evaporator 34 are disposed. The radiator 32 and the evaporator 34 respectively heat and dehumidify drying air which absorbs moisture from a subject to be dried 36 (for example, clothing, bathroom and the like). The drying air is circulated in the air channel 41 by a blowing fan 37.

Moreover, in the present embodiment, the drying apparatus is provided with a first temperature sensor 38 for detecting refrigerant temperature (compressor suction refrigerant temperature) T1 between the outlet of the evaporator 34 and the inlet of the compressor 31. In this case, a method of detecting the refrigerant temperature by means of the first temperature sensor 38 includes a method of directly measuring the refrigerant temperature and a method of indirectly measuring the refrigerant temperature by detecting pipe temperature.

Furthermore, in the present embodiment, the drying apparatus further includes storage means 11, a timer 12, processing means 13, and control means 14. Correlation data between time elapsing from start of operation of the heat pump apparatus and evaporation temperature of the refrigerant in the evaporator 34, and a target superheat value are stored in the storage means 11 in advance. The timer 12 detects operation time of the heat pump apparatus by detecting temperature and/or humidity in the air channel 41 in addition to detection by means of count-up. The processing means 13 estimates the evaporation temperature of the refrigerant based on the operation time detected by the timer 12 and the correlation data stored in the storage means 11, and then estimates a superheat value based on the estimated evaporation temperature and the detected value detected by the first temperature sensor 38. The control means 14 controls flow resistance of the expansion valve 33 so that the superheat value estimated by the processing means 13 becomes the target superheat value stored in the storage means 11. If the pressure or transition of evaporation temperature of the evaporator 34 in accordance with the operation time of the heat pump apparatus is grasped in advance, it is possible to estimate the evaporation temperature at the time using detected values detected by the timer 12 and the first temperature sensor 38. Thus, a superheat value can be obtained as the difference between the estimated evaporation temperature and the detected value by the first temperature sensor 38. In this regard, in FIG. 1, solid arrows represent the flow of the refrigerant, while hollow arrows represent the flow of the drying air.

Next, the operation of the drying apparatus will be explained.

The refrigerant is compressed by the compressor 31 to be brought into a high temperature and high pressure state, and the refrigerant exchanges heat with drying air discharged from the evaporator 34 in the radiator 32 to heat the drying air. The refrigerant cooled in the radiator 32 is decompressed by the expansion valve 33 to become a low temperature and low pressure state. Then, the refrigerant decompressed by the expansion valve 33 exchanges heat with the drying air that has passed through the subject to be dried 36 in the evaporator 34 to cool the drying air. The refrigerant dehumidifies the drying air by condensing moisture included in the drying air, and is heated by the drying air to be sucked in the compressor 31 again. That is a principle of the operation of the heat pump.

Further, the drying air is dehumidified by the evaporator 34, and then heated in the radiator 32 to become a high temperature and low humidity state. When the drying air is forcibly brought into contact with the subject to be dried 36 by the blowing fan 37, the drying air absorbs moisture from the subject to be dried 36 to become a high humidity state, and is then dehumidified by the evaporator 34 again. That is a principle of the drying operation in which moisture is absorbed from the subject to be dried 36.

In this regard, in the case where flow resistance of the expansion valve 33 is made to be larger, the temperature of the refrigerant sucked in the compressor 31 is raised. This is because the pressure of the suction side (from the outlet of the expansion valve 33 to the suction portion of the compressor 31 through the evaporator 34) becomes lower and the amount of the refrigerant in the evaporator 34 is decreased, whereby the refrigerant is easily evaporated and overheated, if the flow resistance of the expansion valve 33 is made to be larger. Therefore, if the flow resistance of the expansion valve 33 is made to be smaller, the temperature of the refrigerant sucked in the compressor 31 can be lowered.

Next, the control operation of the drying apparatus will be explained.

As shown in FIG. 2, operation time t of the heat pump apparatus is detected by the timer 12, and evaporator pressure Pe (=evaporation temperature Te) are estimated using Table of the operation time t and the evaporator pressure Pe (=evaporation temperature Te) prepared in advance (Step 41). Suction temperature Ts of the compressor 31 is then detected by the first temperature sensor 38, and a superheat value TSH (=Ts−Te) is estimated using the detected value Ts and the evaporation temperature Te estimated at Step 41 (Step 42). Next, the superheat value TSH estimated at Step 42 is compared with the target superheat value TC (Step 43). In the case where the superheat value TSH is larger than the target superheat value TC at Step 43, the control means 14 controls flow resistance of the expansion valve 33 to become smaller (Step 44B), and then, the procedure is returned to Step 41. On the other hand, in the case where the superheat value TSH is smaller than the target superheat value TC at Step 43, the control means 14 controls flow resistance of the expansion valve 33 to become larger (Step 44A), and then, the procedure is returned to Step 41.

In the present control operation, by using the detected values of the timer 12 and the first temperature sensor 38, it is possible to control the superheat value to a value close to the optimum value at which the COP becomes maximal.

In the drying apparatus of the present embodiment, the superheat value can converge in the vicinity of the target value, and this makes it possible to avoid lowering the heat pump performance (COP). Namely, it is possible to reduce power consumption as compared with a conventional drying apparatus. In other words, since it is possible to avoid deteriorating the operating efficiency of the drying apparatus, it is possible to utilize CO₂ refrigerant which hardly has impact on the global warming.

The drying apparatus of the present embodiment uses a transition critical refrigeration cycle using CO₂ refrigerant. Therefore, as compared with a conventional subcritical refrigeration cycle using HFC refrigerant, heat exchanging efficiency between CO₂ refrigerant and the drying air in the radiator 32 can be enhanced, and the temperature of the drying air can be increased to high temperature. Thus, the ability for absorbing moisture from the subject to be dried 36 is increased, and this makes it possible to dry the subject to be dried 36 within a short time.

In this regard, in the present embodiment, CO₂ refrigerant which is brought into supercritical state on the radiation side is used, but the conventional HFC refrigerant may be used. Further, even in the case where HC refrigerant such as propane and isobutene is used, the same effect can be obtained.

### Second Embodiment

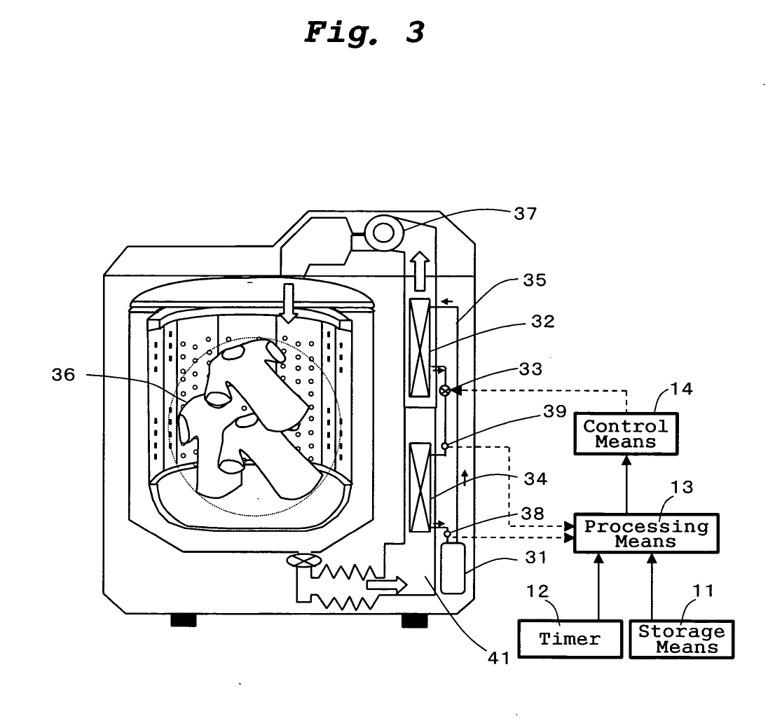

FIG. 3 shows a structure of a drying apparatus of a second embodiment according to the present invention. FIG. 4 is a control flowchart of the drying apparatus of the second embodiment. In this regard, in the following explanation for the second embodiment, the same structures as those of the first embodiment are designated with the same symbols, explanation thereof will be omitted, and the structures of the second embodiment which are different from those of the first embodiment will be explained.

The drying apparatus of the present embodiment includes a second temperature sensor 39 for detecting the refrigerant temperature between the outlet of an expansion valve 33 and the inlet of an evaporator 34 in addition to the structure of the drying apparatus of the first embodiment, and processing means calculates a superheat value based on the difference between the detected values of a first temperature sensor 38 and the second temperature sensor 39. Further, a plurality of values as target superheat values and predetermined time values for applying each of the target superheat values to the heat pump apparatus are stored in the storage means 11. In this case, if the second temperature sensor 39 is applied to a portion in which liquid refrigerant exists, the second temperature sensor 39 may be mounted on the body of the evaporator 34.

Hereinafter, the control operation of the drying apparatus of the second embodiment will be explained.

As shown in FIG. 4, operation time t of the heat pump apparatus detected by a timer 12 is compared with predetermined time t1 stored in the storage means 11 (Step 51). In the case where the operation time t is longer than the predetermined time t1 at Step 51, a superheat value TSH1 obtained from the difference between the detected values of the first temperature sensor 38 and the second temperature sensor 39 is compared with a target superheat value TC1 (Step 52). In the case where the superheat value TSH1 is larger than the target superheat value TC1 at Step 52, control means 14 controls flow resistance of the expansion valve 33 to become smaller (Step 53A), and then, the procedure is returned to Step 52. On the other hand, in the case where the superheat value TSH1 is smaller than the target superheat value TC1 at Step 52, the control means 14 controls flow resistance of the expansion valve 33 to become larger (Step 53B), and then, the procedure is returned to Step 52.

Further, in the case where the operation time t is shorter than the predetermined time t1 at Step 51, a superheat value TSH2 obtained from the difference between the detected values of the first temperature sensor 38 and the second temperature sensor 39 is compared with a target superheat value TC2 (Step 54). In the case where the superheat value TSH2 is larger than the target superheat value TC2 at Step 54, the control means 14 controls flow resistance of the expansion valve 33 to become smaller (Step 55A), and then, the procedure is returned to Step 51. On the other hand, in the case where the superheat value TSH2 is smaller than the target superheat value TC2 at Step 54, the control means 14 controls flow resistance of the expansion valve 33 to become larger (Step 55B), and then, the procedure is returned to Step 51. In this regard, the target superheat value TC2 is a superheat value at which the COP becomes optimal, and the target superheat value TC1 is set to a superheat value larger than the target superheat value TC2.

According to the control operation, since the superheat value is made to become larger after predetermined time elapses from the start of the drying process, the temperature of the drying air can be raised. Thus, by adding selection means (not shown in the drawings) for selecting whether the target superheat value TC2 is applied to the heat pump apparatus or not to the drying apparatus of the present embodiment, it is possible to select either reduction of the power consumption or shortening of the drying time in response to intention of a user of the drying apparatus. In this case, although the case where the target superheat value is changed from the target superheat value TC2 to the target superheat value TC1 at the predetermined time t1 has been explained in the present embodiment, the target superheat value may be raised with three steps or more, or may be raised consecutively. Moreover, in the first embodiment described above, the plurality of target superheat values may be set as the present embodiment. In the case of setting the plurality of target superheat values, it is preferable to add selecting means (not shown in the drawings) to the drying apparatus of the first embodiment.

### Third Embodiment

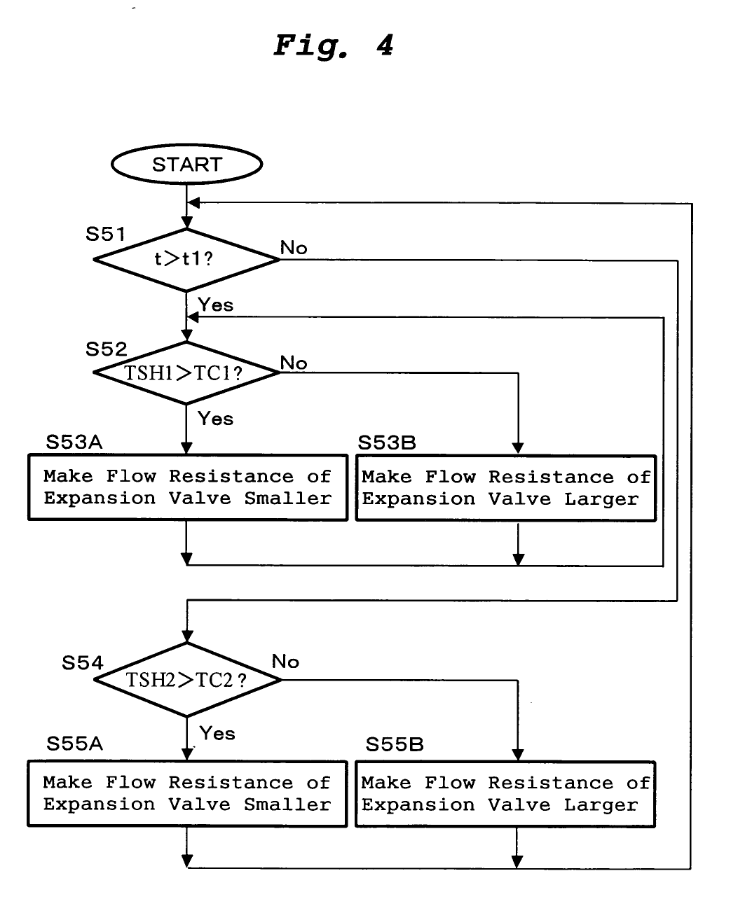

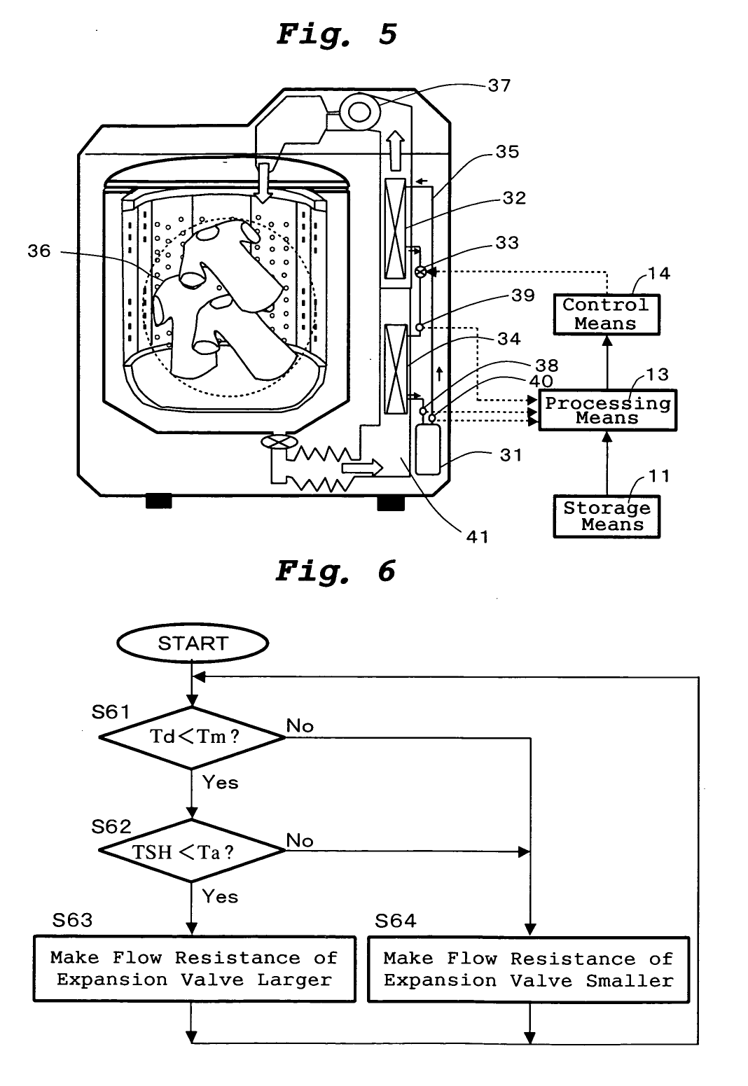

FIG. 5 shows a structure of a drying apparatus of a third embodiment according to the present invention. FIG. 6 is a control flowchart of the drying apparatus of the third embodiment. In this regard, in the following explanation for the third embodiment, the same structures as those of the second embodiment are designated with the same symbols, explanation thereof will be omitted, and the structures of the second embodiment which are different from those of the second embodiment will be explained.

The drying apparatus of the present embodiment includes a third temperature sensor 40 for detecting the temperature of the refrigerant between the outlet of a compressor 31 and the inlet of an expansion valve 33 in addition to the structure of the drying apparatus of the second embodiment. Control means 14 controls flow resistance of the expansion valve 33 using the difference (that is, a superheat value) between the detected values of a first temperature sensor 38 and a second temperature sensor 39 and the detected value from the third temperature sensor 40. In this case, the drying apparatus of the third embodiment does not include a timer 12 for detecting operation time of the drying apparatus with which the drying apparatus of the second embodiment is provided.

Hereinafter, the control operation of the drying apparatus of the third embodiment will be explained.

As shown in FIG. 6, suction temperature Td detected by the third temperature sensor (suction temperature detecting means) 40 is compared with preset temperature Tm (for example, 100° C.) (Step 61). In the case where the suction temperature Td is higher than the preset temperature Tm at Step 61, the control means 14 controls flow resistance of the expansion valve 33 to become smaller (Step 64), and then, the procedure is returned to Step 61. In the case where the suction temperature Td is lower than the preset temperature Tm at Step 61, a superheat value TSH obtained from the difference between the detected values of the first temperature sensor 38 and the second temperature sensor 39 is compared with a target superheat value Ta (for example, 10 deg) (Step 62). In the case where the superheat value TSH is larger than the target superheat value Ta at Step 62, the control means 14 controls flow resistance of the expansion valve 33 to become smaller (Step 64), and then, the procedure is returned to Step 61. On the other hand, in the case where the superheat value TSH is smaller than the target superheat value Ta at Step 62, the control means 14 controls flow resistance of the expansion valve 33 to become larger (Step 63), and then, the procedure is returned to Step 61.

Generally, in the case where the superheat value is increased, the compressor suction temperature is increased and the compressor discharge temperature is increased. However, in the drying apparatus of the third embodiment, by detecting the discharge temperature of the compressor 31 and the superheat value and controlling flow resistance of the expansion valve 33 based on the detected values, the superheat value can converge in the vicinity of the target value at which the COP becomes maximal in a state where the discharge temperature does not exceed a permissible range of the compressor 31. Thus, it is possible to prevent employed materials of the compressor 31 (for example, a seal member) or refrigerating machine oil from deteriorating, and this makes it possible to exert the maximum heat pump performance while ensuring the reliability of the compressor 31 more surely. In other words, the heat pump apparatus can carry out the heat pump cycle operation with stability and high efficiency. In this regard, even in the present embodiment, the superheat value may be made to become larger after predetermined time elapses from the start of the drying process as the second embodiment, and the temperature of the drying air may be raised. Further, by adding determining means for determining whether the target superheat value Ta is applied to the heat pump apparatus or not, it is possible to select either reduction of the power consumption or shortening of the drying time in response to intention of a user of the drying apparatus. In addition, the target superheat value may be raised with three steps or more even in the present embodiment.

### Fourth Embodiment

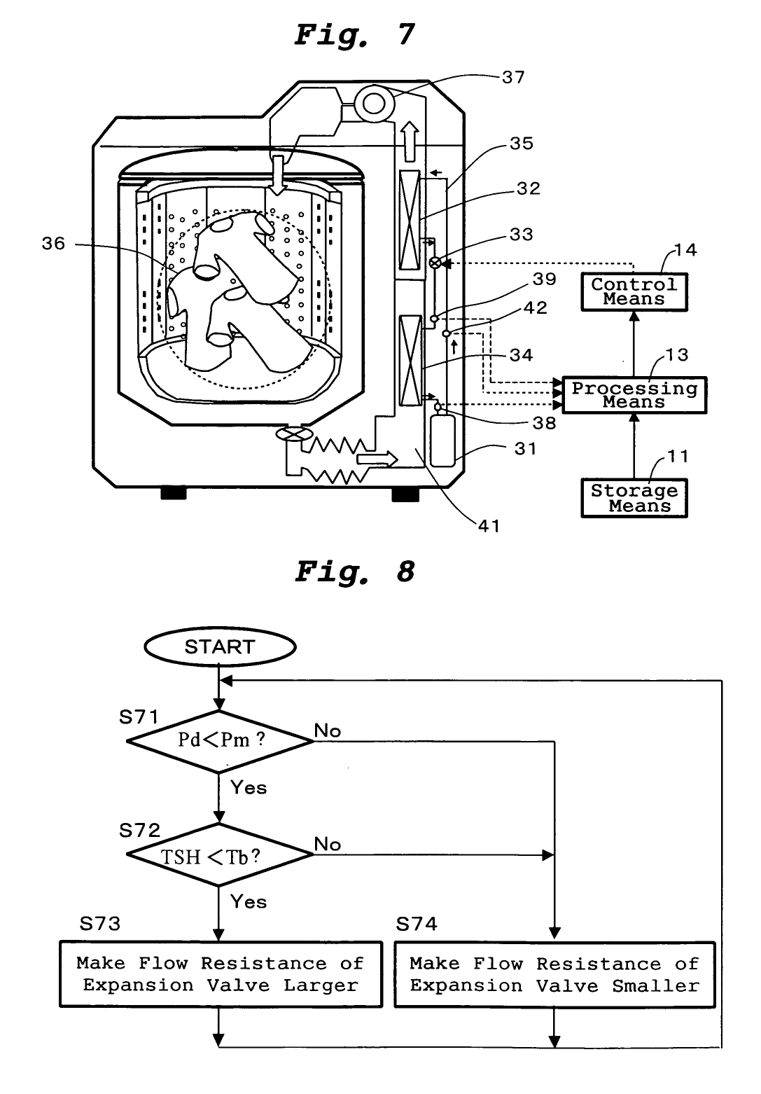

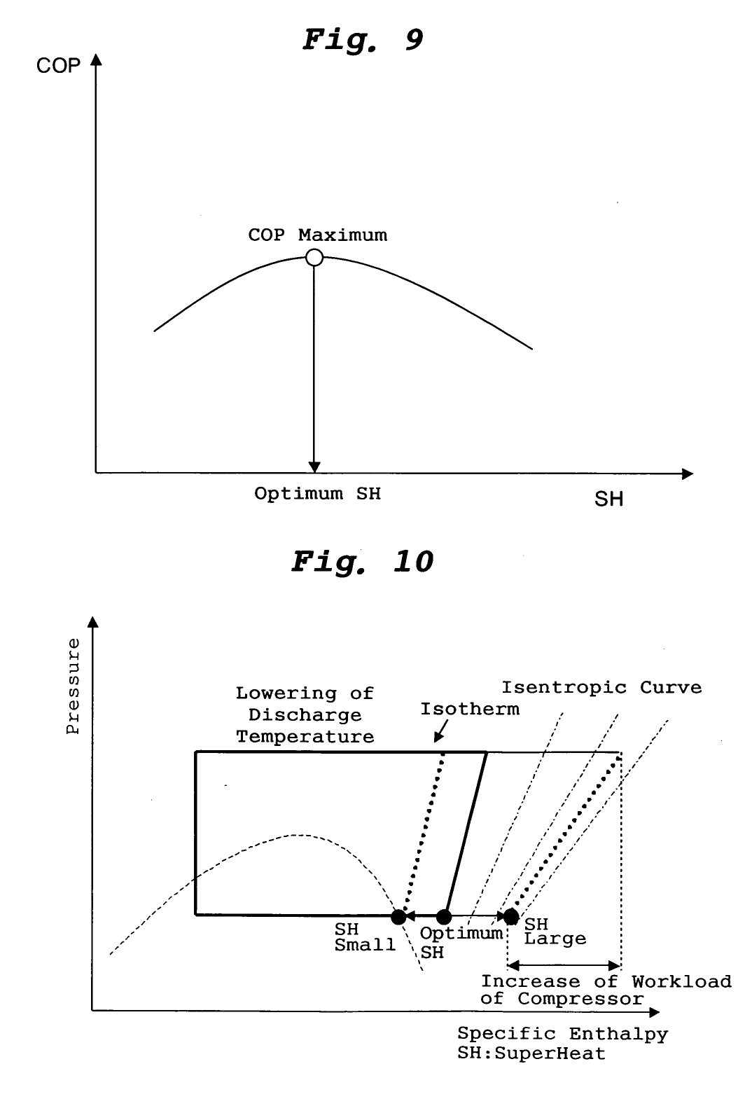

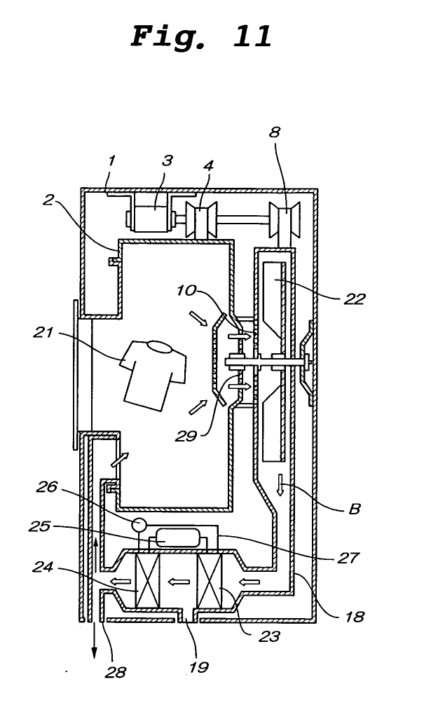

FIG. 7 shows a structure of a drying apparatus of a fourth embodiment according to the present invention. FIG. 8 is a control flowchart of the drying apparatus of the fourth embodiment.

The drying apparatus of the present embodiment includes discharge pressure detecting means 42 for detecting the discharge pressure of a compressor 31 in addition to the structure of the drying apparatus of the second embodiment. Control means 14 controls flow resistance of an expansion valve 33 using the difference (that is, a superheat value) between the detected values of a first temperature sensor 38 and a second temperature sensor 39 and the detected value from the discharge pressure detecting means 42. In this case, the drying apparatus of the fourth embodiment does not include a timer 12 for detecting operation time of the drying apparatus with which the drying apparatus of the second embodiment is provided.

Hereinafter, the control operation of the drying apparatus of the fourth embodiment will be explained.

As shown in FIG. 8, discharge pressure Pd detected by the discharge pressure detecting means 42 is compared with preset pressure Pm (for example, 12 MPa) (Step 71). In the case where the discharge pressure Pd is higher than the preset pressure Pm at Step 71, the control means 14 controls flow resistance of the expansion valve 33 to become smaller (Step 74), and then, the procedure is returned to Step 71. In the case where the discharge pressure Pd is lower than the preset pressure Pm at Step 71, a superheat value TSH obtained from the difference between the detected values of the first temperature sensor 38 and the second temperature sensor 39 is compared with a target superheat value Tb (for example, 10 deg) (Step 72). In the case where the superheat value TSH is larger than the target superheat value Tb at Step 72, the control means 14 controls flow resistance of the expansion valve 33 to become smaller (Step 74), and then, the procedure is returned to Step 71. On the other hand, in the case where the superheat value TSH is smaller than the target superheat value Tb at Step 72, the control means 14 controls flow resistance of the expansion valve 33 to become larger (Step 73), and then, the procedure is returned to Step 71.

Generally, when the flow resistance of the expansion valve 33 is made to be larger in order to increase the superheat value, the compressor discharge pressure is increased. However, in the drying apparatus of the fourth embodiment, by detecting the discharge pressure of the compressor 31 and the superheat value and controlling flow resistance of the expansion valve 33 based on the detected values, the superheat value can converge in the vicinity of the target value at which the COP becomes maximal in a state where the discharge pressure does not exceed a permissible range of the compressor 31. Thus, the heat pump apparatus can carry out the heat pump cycle operation below the withstanding pressure of a shell of the compressor 31, and this makes it possible to exert the maximum heat pump performance while ensuring the reliability of the compressor 31 more surely. In other words, the heat pump apparatus can carry out the heat pump cycle operation with stability and high efficiency. In this regard, even in the present embodiment, the superheat value is made to become larger after predetermined time elapses from the start of the drying process as the second embodiment, and the temperature of the drying air may be raised. Further, by adding determining means for determining whether the target superheat value Ta is applied to the heat pump apparatus or not to the drying apparatus of the present embodiment, it is possible to select either reduction of the power consumption or shortening of the drying time in response to intention of a user of the drying apparatus. In addition, the target superheat value may be raised with three steps or more even in the present embodiment.

### INDUSTRIAL APPLICABILITY

The drying apparatus of the present invention can suitably be used for drying clothing, bathroom and the like. Further, the drying apparatus can also be used for other application such as for drying tableware, garbage and the like.

1. A drying apparatus comprising a heat pump apparatus composed by sequentially connecting in series: a compressor that compresses a refrigerant; a radiator that radiates the refrigerant discharged from the compressor; an expansion valve that expands the refrigerant radiated in the radiator; and an evaporator that evaporates the refrigerant expanded by the expansion valve, and an air channel in which drying air heated in the radiator is introduced to a subject to be dried, the drying air that absorbs moisture from the subject to be dried being dehumidified in the evaporator, and the dehumidified air being then heated in the radiator again to reuse the dehumidified air as the drying air, the drying apparatus comprising:
a first temperature sensor for detecting the temperature of the refrigerant between the outlet of the evaporator and the inlet of the compressor; and
control means for controlling a superheat value by changing flow resistance of the expansion valve based on a detected value of the first temperature sensor.

2. The drying apparatus according to claim 1, further comprising:
storage means for storing correlation data between time elapsing from start of operation of the heat pump apparatus and evaporation temperature of the refrigerant in the evaporator, and a target superheat value in advance;
a timer for detecting operation time of the heat pump apparatus; and
processing means which estimates the evaporation temperature of the refrigerant based on the operation time detected by the timer and the correlation data stored in the storage means, and then estimates a superheat value based on the estimated evaporation temperature and the detected value detected by the first temperature sensor,
wherein the control means controls the flow resistance of the expansion valve so that the superheat value estimated by the processing means becomes the target superheat value stored in the storage means.

3. The drying apparatus according to claim 1, further comprising:
storage means for storing a target superheat value in advance;
second temperature sensor for detecting the temperature of the refrigerant between the outlet of the expansion valve and the inlet of the evaporator; and
processing means which calculates a superheat value based on a detected value detected by the second temperature sensor and the detected value detected by the first temperature sensor,
wherein the control means controls the flow resistance of the expansion valve so that the superheat value calculated by the processing means becomes the target superheat value stored in the storage means.

4. The drying apparatus according to claim 2, wherein the control means controls the flow resistance of the expansion valve so that the superheat value after the operation time of the heat pump apparatus elapses beyond predetermined time becomes larger than that before the predetermined time elapses.

5. The drying apparatus according to claim 3, further comprising:
a timer for detecting operation time of the heat pump apparatus, wherein the control means controls the flow resistance of the expansion valve so that the superheat value after the operation time of the heat pump apparatus elapses beyond predetermined time becomes larger than that before the predetermined time elapses.

6. The drying apparatus according to claim 4, further comprising:
selection means for selecting whether to apply the superheat value larger than that before the predetermined time elapses to that after predetermined time elapses or not.

7. The drying apparatus according to claim 1, further comprising:
a third temperature sensor for detecting the temperature of the refrigerant between the outlet of the compressor and the inlet of the expansion valve.

8. The drying apparatus according to claim 7, wherein, in the case where a detected value detected by the third temperature sensor becomes predetermined temperature or more, the control means controls the expansion valve so as to make the flow resistance of the expansion valve smaller.

9. The drying apparatus according to claim 1, further comprising:
discharge pressure detecting means for detecting discharge pressure of the compressor.

10. The drying apparatus according to claim 9, wherein, in the case where a detected value detected by the discharge pressure detecting means becomes predetermined pressure or more, the control means controls the expansion valve so as to make the flow resistance of the expansion valve smaller.

11. The drying apparatus according to claim 5, further comprising:
selection means for selecting whether to apply the superheat value larger than that before the predetermined time elapses to that after predetermined time elapses or not.
